(19) United States
(12) Patent Application Publication
(10) Pub. No.: US 2014/0006518 A1
(43) Pub. Date: Jan. 2, 2014

(54) INSTANT MEETINGS WITH CALENDAR FREE SCHEDULING

(71) Applicant: EVERNOTE CORPORATION, Redwood City, CA (US)

(72) Inventor: Andrew Sinkov, San Francisco, CA (US)

(73) Assignee: Everote Corporation, Redwood City, CA (US)

(21) Appl. No.: 13/870,379

(22) Filed: Apr. 25, 2013

Related U.S. Application Data
(60) Provisional application No. 61/664,908, filed on Jun. 27, 2012.

(51) Int. Cl. H04L 12/58

(52) U.S. Cl. CPC H04L 51/32
USPC 709/205

(57) ABSTRACT

Arranging a meeting between participants includes choosing a set of possible meeting participants, possible meeting times, and possible meeting venues. A possible meeting is announced without knowledge of availability of at least some of the set of possible meeting participants. Some of the possible participants provide preferences for proposed meeting times and/or proposed meeting venues. A subset of meeting participants is automatically selected to meet at at least one particular location at at least one particular time at at least one particular venue according to preferences and availability of at least some of the set of possible meeting participants, where the subset of meeting participants is less than the set of possible meeting participants and where the subset of meeting participants is chosen based on the particular meeting venues and times. An invitation is sent to the subset of meeting participants.

### CROSS-REFERENCE TO RELATED APPLICATIONS

This application claims priority to U.S. Prov. App. No. 61/664,908, filed Jun. 27, 2012, and entitled “METHOD AND SYSTEM FOR SETTING UP INSTANT MEETINGS WITH CALENDAR FREE SCHEDULING”, which is incorporated herein by reference.

### TECHNICAL FIELD

This application relates to the field of Internet communications and cloud-based services, particularly in connection with personal information management and scheduling.

### BACKGROUND OF THE INVENTION

It has been estimated that the number of connected mobile devices in use, including mobile phones and tablets, currently exceeds the world population. In addition, market forecasts indicate that, by 2016, there will be over 10 billion of Internet-connected mobile devices, of which approximately eight billion will be smartphones and tablets.

Pervasive usage of mobile devices leads to fast growth of social mobile services. While many popular online services with increasing mobile presence, such as Facebook, Twitter and Tumblr, connect people in the virtual world, many other services are bringing together the digital and the real worlds. Examples include location-based social networks and social discovery projects, such as Foursquare, Highlight, Skout; appointment scheduling service ZocDoc; auto renting services Uber, GetAround, and Zipcar; meeting and event organizing sites and services Meetup and Constant Contact, and many others. These services aim at bringing together new people who never met each other before; offering tangible amenities, such as car/cab renting or doctor visits; etc. A significant number of services is integrated with users' mobile calendars and relies on them while scheduling meetings, appointments, and events.

In spite of recent advances, a significant area of conventional meetings between friends in their spare time has been left untouched. Mobile users don't receive much help in setting up their meeting during the time which is often marked by gray unscheduled space on their calendars, normally starting at 5 pm+ on workdays and/or occupying most of the day on weekends. Time, location, traffic, mood, friends' plans, individual and group interests and preferences, available local events and venues and many more factors play their roles in answering the question “how do I spend this evening?”

Accordingly, it is desirable to develop methods and systems for facilitating instant meetings between friends who haven't pre-scheduled any activities for a slot of their free time and rely on a mobile service to fill in the gap.

### SUMMARY OF THE INVENTION

According to the system described herein, arranging a meeting between participants includes choosing a set of possible meeting participants, choosing a set of possible meeting times, choosing a set of possible meeting venues, announcing a possible meeting without knowledge of availability of at least some of the set of possible meeting participants, receiving, from at least some of the set of possible participants, preferences for at least one of: proposed meeting times and proposed meeting venues, automatically selecting a subset of meeting participants to meet at at least one particular location at at least one particular time at at least one particular venue according to preferences and availability of at least some of the set of possible meeting participants, where the subset of meeting participants is less than the set of possible meeting participants and where the subset of meeting participants is chosen based on the particular meeting venues and times, and sending an invitation to the subset of meeting participants. A first one of the participants may be a meeting organizer that initially chooses the set of possible meeting participants, the set of possible meeting times, and the set of possible meeting venues. A second one of the participants may become the meeting organizer while the first one of the participants is no longer the meeting organizer Prior to sending the invitation, the meeting organizer may eliminate choices from the subset of meeting participants, the at least one particular location, the at least one particular time, and/or the at least one particular venue. In response to the subset of meeting participants being less than two, the organizer may relax requirements for the meeting by choosing more possible meeting participants, adding possible meeting venues, adding possible meeting times, and/or expanding already-specified possible meeting times. After receiving the invitation, the subset of meeting participants may select the at least one particular location, the at least one particular time, and/or the at least one particular venue. The subset of meeting participants may be determined based at least in part on travel time for each of the possible meeting participants to a location of each of the set of possible meeting venues. The subset of meeting participants may negotiate a best meeting place and time after receiving the invitations. Following agreeing on a meeting place and time, confirmations and final meeting details may be sent to the subset of meeting participants. Following agreeing on a meeting place and time, a number of members of the subset of meeting participants may be decreased. Following agreeing on a meeting place and time, travel and meeting times may be blocked out for all of the subset of meeting participants. Following agreeing on a meeting place and time, the meeting place and time may be announced via social networks for others to join. Following agreeing on a meeting place and time, tracking information about at least some of the subset of meeting participants with location aware mobile devices may be provided to other ones of the participants. Following agreeing on a meeting place and time, the meeting place and time may be provided to invite others to join the meeting and the others may not be part of the set of possible meeting participants. The set of possible meeting venues may include virtual meeting venues and/or at least one venue that is mixed real and virtual, where some of the set of possible meeting participants meet in-person while others meet virtually.

According further to the system described herein, computer software, provided in a non-transitory computer-readable medium, arranges a meeting between participants. The software includes executable code that announces a possible meeting at possible meeting times and at possible meeting venues without knowledge of availability of at least some of a set of possible meeting participants, executable code that receives from at least some of the set of possible participants preferences for proposed meeting times and/or proposed meeting venues, executable code that selects a subset of meeting participants to meet at at least one particular location at at least one particular time at at least one particular venue according to preferences and availability of at least some of the set of possible meeting participants, where the subset of meeting participants is less than the set of possible meeting participants and where the subset of meeting participants is chosen based on the particular meeting venues and times and executable code that sends an invitation to the subset of meeting participants. A first one of the participants may be a meeting organizer that initially chooses the set of possible meeting participants, the possible meeting times, and the possible meeting venues. A second one of the participants may become the meeting organizer while the first one of the participants is no longer the meeting organizer In response to the subset of meeting participants being less than two, the requirements may be relaxed for the meeting by more possible meeting participants being chosen, possible meeting venues being added, possible meeting times being added, and/or already-specified possible meeting times being expanded. The subset of meeting participants may be determined based at least in part on travel time for each of the possible meeting participants to a location of each of the possible meeting venues. The software may also include executable code that sends confirmations and final meeting details to the subset of meeting participants. The software may also include executable code that blocks out travel and meeting times for all of the subset of meeting participants. The software may also include executable code that announces the meeting place and time via social networks for others to join. The software may also include executable code that tracks information about at least some of the subset of meeting participants with location aware mobile devices and provides the information to other ones of the participants. The software may also include executable code that provides the meeting place and time to invite others to join the meeting, where the others are not part of the set of possible meeting participants. The possible meeting venues may include virtual meeting venues and/or at least one venue that is mixed real and virtual, where some of the set of possible meeting participants meet in-person while others meet virtually.

The proposed system acts as a cloud-based service connecting multiple mobile devices. The system may track user availability during their spare time based on users' manual instructions, gaps in their mobile calendars, or via semi-automatic notifications on a user mobile device that require confirmation and indication of free time span by the user. When a candidate list is sufficiently populated based on free time periods, the system may determine various possibilities for friends to meet based on their preferences, location, travel times, available venues, and other factors. Suggestions may be sent to friends for a confirmation; friends may choose between several options and may discuss alternative venues via instant communications. Once confirmations are received and the time, place and the initial list of participants are mutually agreed upon, an “instameet” group may be created by the system; participants' schedules maintained by the service may be updated by blocking travel and meeting times from participants' availability time periods. For participants who are traveling to the meeting place with location-aware devices, the system may track and broadcast their trips to the rest of the group. The system may also offer the appropriate communication methods to the participants of a meeting.

The system starts functioning for an individual user when that user logs in, joins the list of meeting candidates maintained by the system and is considered by the system as a meeting organizer Users may join the list of meeting candidates by giving manual instructions, such as “free for 5 hours right away” or “will be free for three hours in an hour”. Alternatively, the system may process user availability periods by discovering gaps in their mobile calendars at predefined times—say, “nothing scheduled after 6 pm”. Another embodiment may display to the user a predefined number of reminders around their default or customized spare time asking to confirm availability (“yes, I am available for the next 3 hours”). In addition to the availability for a given time period, the user may specify certain limitations and requests, such as maximum travel distance (“will travel 15 miles max”, “will spend max 30 min. driving”, etc.), desirable venue, which may be a category (“prefer pub or country music concert”) or a specific meeting place (for example, “see you at Pier 39”), and other circumstances (examples are, “won't drive, need pick-up”; “need public transportation hints”); candidates may also supply descriptions for certain meeting places or activities (“bring masquerade costumes”). In addition to the above meeting conditions, the user may restrict a choice of friends for the meeting to specific individuals from the friends list.

After a meeting organizer has joined the list and formulated meeting conditions, the system starts the matching process between the organizer and available friends. In one embodiment, the system first looks for friends, venues, and timeframes that satisfy all organizer requirements and where the venues, locations, driving times and other restrictions hold for each potential participant of the meeting. There may be certain conflicts in the matching process: for example, even if all location, time, venue and some other parameters are satisfied for each participant chosen by the system, the preferences of the participants of seeing each other at the meeting may be asymmetric (e.g. non-transitive); thus, two desirable friends for a candidate for whom the current list of meetings is being created may not be willing to meet each other. The system may apply various rules for conflict resolution. In the above example, two different meetings at the same place but with different groups of friends may be offered to the organizer based on an analysis of friends' lists of each potential participant. If there are no meetings satisfying all requirements of the candidate and of at least one among the chosen friends, the system may weaken some of the conditions according to system priorities or user-defined priorities in order to broaden meeting opportunities. For example, the system may start with broadening a set of venues acceptable for participants by choosing relevant or close categories to those suggested by participants (say, “jazz concert” instead of “country music concert”); then the system may gradually increase distance and travel time to the meeting place. In this way, second and subsequent circles of meeting offerings may be built.

Following the initial arrangements, the system displays to the candidate the list of meetings sorted by relevance, measured as the degree of satisfying candidate's conditions, or by other parameters, such as, for example, a number of friends that may be able to attend each meeting, travel distance, estimated travel time, duration of each meeting based on available time slots by friends, etc. The candidate may choose the best option and invite friends. Alternatively, the candidate may choose several options from the list and the system may assist the candidate and friends negotiating the best arrangement for their meeting. During the discussion of meeting opportunities, the system may offer communications options to all users, such as a text or voice chat, social networks (for example, a Facebook page where the offers are published and discussed or a Twitter stream) or other venues.

Once a group of friends has confirmed a meeting according to the above process, an “instameet group” is created and participants' availability schedules in the system are updated. For example, if the estimated duration of a meeting, including a participant travel time to the meeting place, is three hours, the three hours are blocked for each participant; if any participant had previously announced a significantly longer availability period compared with the meeting time, the rest of the period may still be considered free and the participant may receive other meeting invitations for the residual time. Participants may also declare a meeting open, which will make the meeting discoverable by other system users. Additionally, the system may post an instant meeting to other social services, such as Twitter, Facebook or Meetup, which enables other friends joining the meeting if it is applicable for the venue type (e.g. café vs. concert) and reasonable with respect to time/location/other limitations.

After an instant meeting has been created, some or all participants may be traveling to the meeting place. The system may support tracking of participants' routes for the participants traveling with location-aware mobile devices. As an example, the system may broadcast to other participants a map with all participant locations (some at meeting place, others on their way), supplemented with estimated arrival time. The system may also offer adequate communications mechanisms based on each participant's status, such as hands free phone call for driving users and other appropriate means for users who have already arrived to the meeting place or travel by public transport.

As explained elsewhere herein, in the event that a meeting was broadcasted as an “open instameet”, during the meeting participants may receive additional requests to join them. Also, participants who have announced their availability beyond the end of the current meeting may receive invitations from the system to subsequent meetings with other friends based on the end time and their current location.

One implementation of the system may be achieved through its bundling with built-in and aftermarket Internet-connected car traffic navigators. Such an implementation may instantly provides location awareness, hands-free operations (including voice commands and communications) and sufficient display space, with maps and POIs already present in the car navigation system and used for multiple purpose.

While the proposed system aims, in the first place, at real-life meetings between participants, it may also be used for arranging virtual meetings (for example, multi-player games between friends) and for mixed real/virtual meetings where some participants meet in-person, while others are connecting to their mobile devices to participate remotely via audio/video conference.

### BRIEF DESCRIPTION OF THE DRAWINGS

Embodiments of the system described herein will now be explained in more detail in accordance with the figures of the drawings, which are briefly described as follows.

FIG. 1 is a system architecture chart with key functional components according to an embodiment of the system described herein.

FIG. 2 is a schematic illustration of a meeting arrangement and conduct process according to an embodiment of the system described herein.

FIG. 3 is a schematic illustration of a process of selection of available meeting venues and friends according to an embodiment of the system described herein.

FIG. 4 is a schematic illustration of an invitation, discussions between friends, meeting confirmation and travel processes according to an embodiment of the system described herein.

FIG. 5 is a schematic illustration of a meeting conduct with additional friends' arrivals according to an embodiment of the system described herein.

FIG. 6 is a flow diagram illustrating initiating and conducting a meeting according to an embodiment of the system described herein.

FIG. 7 is a system flow diagram illustrating initial setup process by a candidate according to an embodiment of the system described herein.

FIG. 8 is a system flow diagram illustrating a choice of available meeting options by the system according to an embodiment of the system described herein.

FIG. 9 is a system flow diagram illustrating a meeting invitation and confirmation process according to an embodiment of the system described herein.

### DETAILED DESCRIPTION OF VARIOUS EMBODIMENTS

The system described herein provides an online service for setting up nearly instant meetings between friends and other participants of diverse physical and online activities, including search of meeting venues, invitations and selection of the best meeting place, tracking traveling participants and inviting additional guests. The system offers different techniques for announcing a spare time period, setting up time, space, venue, participant and other requirements, as explained elsewhere herein; in particular, the system provides techniques for setting up and broadcasting instameet groups via social media. The system replaces a traditional calendar-centric scheduling process with a free-form organization of meetings where participants are presented with viable meeting alternatives satisfying their time and space requirements and interests and where the relevant content circulates between the prospective meeting participants.

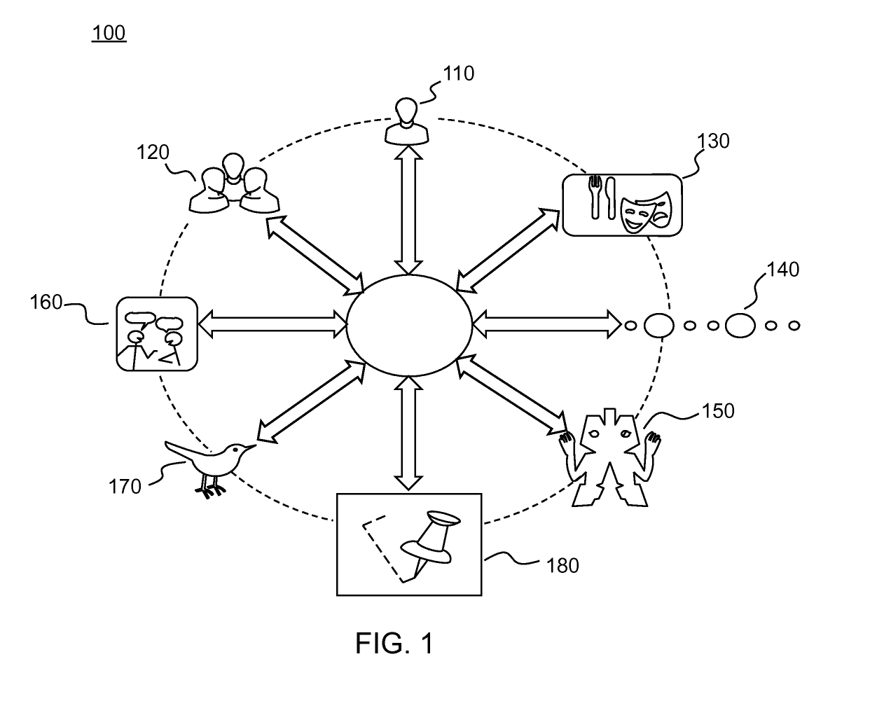

FIG. 1 is a system architecture chart 100 that includes functional components. A meeting organizer 110 is a user of the online meeting service who may announce a spare time period and desirable meeting parameters and task the system with designing and arranging an optimal meeting within the requirements and limitations set by the organizer The meeting organizer 110 may be one of the participants. In some embodiments, it is possible for a first participant to be the initial meeting organizer and then a second participant takes over being meeting organizer while the first participant relinquishes the meeting organizer role.

The user selects one or several friends from a friend list 120, which may be created or updated at any time. The user also chooses one or several meeting venues from an available set of venues 130. The user may include both types of the particular destinations and/or venue categories. For the first type, the system matches friends' availability, location, travel time, interests, and other profile parameters trying to choose optimal venues from the presented list. For the second type, the system attempts to locate the venues best satisfying the above requirements and belonging to the presented categories. It should be noted that, in a search of available venues by categories, places, event schedules, booking capabilities and other information, the system may interoperate with other relevant online services and information systems, such as Yelp, OpenTable, Foursquare and similar systems. Note also that the meeting venue may be a virtual meeting, such as a multi-player game between friends. The meeting venue could also be mixed real and virtual, where some participants meet in-person while others meet virtually by, for example, being connected using mobile devices to participate remotely via audio/video conferencing.

The system may calculate and display all or some of the significant phases of the meeting setup and scheduling on a timeline 140, which may be shared with prospective meeting participants. The timeline 140 may be updated based on friends' availability and the discussions on the suggested venues, event calendars, travel arrangements, etc.

After the system has detected a single venue or a set of venues best matching preferences of both the organizer and preferences of friends of the organizer, the system sends out invitations to all participants via an invitation subsystem 150 (all lists of participants include the organizer, but the lists of friends may be different for different venues). When the system organizes the meeting in a semi-automatic mode, the system only chooses the venues and the corresponding participant lists that satisfy all time, space and other requirements, save unforeseen circumstances. Alternatively, an organizer may personally select a venue or a list of venues and send invitations to some or all friends via the invitation subsystem 150. In the latter case, the system may warn the organizer that some of the participants may not be available because of conflicting meetings or other activities, current locations, interests or other factors. During negotiations of a best venue or defining final meeting details, participants may use diverse communications methods, including chat or other conferencing methods 160 and/or social networks 170. Additionally, after the meeting place and time have been chosen and an instameet group created, participants may declare the meeting open to others and instruct the system to publish the meeting info via social networks (examples are Twitter, Facebook or Meetup) for others to join. Alternatively, meeting notifications (not necessarily invitations) may be sent out via the system only to friends of participants or to a coordinated list of their mutual friends.

After the meeting location and time has been chosen, the meeting has been booked (if necessary) and each participant's timeline 140 has been updated, some of the participants may travel to the meeting place. In this case, for participants traveling with location aware devices compatible with the system, a travel tracking subsystem 180 of a location aware device may display, to other participants, a location and a dynamically estimated arrival time, subject to security limitations for traveling participants.

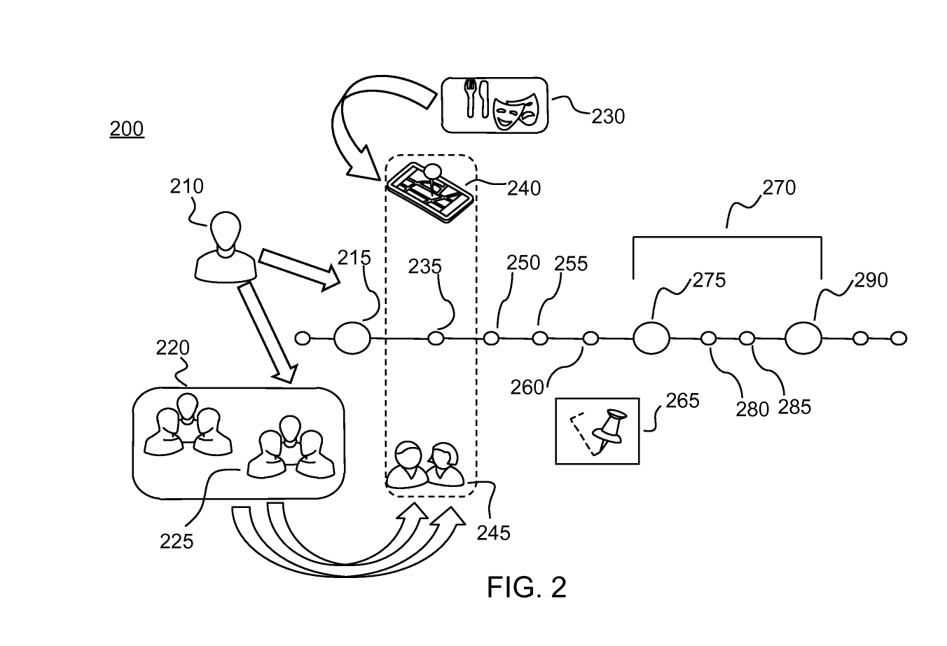

FIG. 2 is a schematic illustration 200 of a meeting arrangement and conduct process fulfilled by the system in an interactive or fully automatic mode. The process begins when a user of the system (an online service subscriber) 210 communicates to the system the start of a spare time period 215, the duration of spare time period, possibly current location (which may also be captured automatically by the system) to seek a meeting with friends, thus becoming a meeting organizer The user may look at a list of friends 220 stored by the system and select a group of friends 225 whom the organizer wants to meet at that particular time. Such pre-selection does not cause the actual meeting to include all individuals 210, 225; instead, the pre-selection merely means that the group 225 includes all prospective meeting candidates at a first iteration of planning.

Following or preceding friend selection 225, the organizer may choose a preliminary list of one or more meeting venues 230. The meeting venues 230 may be a single place, a set of possible meeting places, a category of meeting places or a combination of the two latter options. The systems may assist the organizer in preliminary venue choices, as explained elsewhere herein. Subsequently, the system may begin a planning phase 235 by matching the preliminary list of venues 230 against travel times for each of the meeting candidates 225 (with due respect to available weather and traffic conditions), which results in the meeting durations; event schedules, booking capabilities and user interests may also be taken into account (if applicable) and may result in a score of each available venue. The result of such calculation may be a weighted list of available meeting places 240 and a sub-selection 245 of the preliminary selection of friends by the organizer The new friends list 245 allows each individual on the list to participate in at least one of the available meetings. If the planning phase is unsuccessful and there are no friends and/or venue available for a meeting that satisfies the time, place and other limitations of the organizer and at least one other participant, then the system may suggest that the organizer relax some of the requirements, such as choosing more friends, expanding the list of venues or allowing longer travel times.

At the end of the planning phase 235, the organizer may be presented with the list of available meeting places 240 and the group of friends 245 who may participate in some or all of the meetings. The organizer may still edit the lists and choose a subset of meetings, which will also define the list of friends who may participate in those meetings. If the planning phase 235 was completed successfully, i.e. resulted in one or more meetings with some or all of the selected friends, then the user (organizer) moves to a next phase 250 where the organizer sends invitations to the prospective participants of the list of meetings 240 filtered by the organizer Each friend may receive a list of one or more meeting places with time, travel and other details. At this phase, participants may negotiate the best meeting place and time using interactive and shared system capabilities or other communication means, such as a chat or social networking, as explained elsewhere herein. After the users have agreed on an ultimate meeting place and time, an instameet phase 255 takes place, where the instameet group may be created; confirmations and final meeting details may be sent to all participants on behalf of the group. The system may also block out travel and meeting times from all participants' calendars. If the meeting is open to others, it may be announced via social networks or via other system capabilities for others to join, as explained elsewhere herein.

The creation of the instameet group and related confirmation and scheduling activities complete a planning phase and open an actual meeting phase. Some or all of the participants may have to travel to the meeting place, as shown by a phase 260 on the timeline. For participants who are traveling with mobile location aware devices compatible with the system (such as smartphones logged into the system or car navigators with Internet access bundled with the system software and service capabilities) the system may track the travel progress of participants with mobile aware location devices, as shown by an item 265. The system may communicate the progress of participants with mobile aware location devices to other participants who have a capability of accepting such tracking information. For example, for other traveling participants, information on the group travel may be converted into voice format.

A meeting 270 starts when the first two participants arrive and enter the meeting place, which is schematically shown by an item 275. Other participants may arrive at later times, presumably not later than a meeting end time 290. During the meeting, other friends may join the meeting as illustrated by an item 280 and participants may be receiving invitations to later meetings if the participants elected to do so, as shown by an item 285. After an end time 290 of the meeting illustrated in FIG. 2, some or all of the participants may be planning a next meeting or moving to a new meeting place.

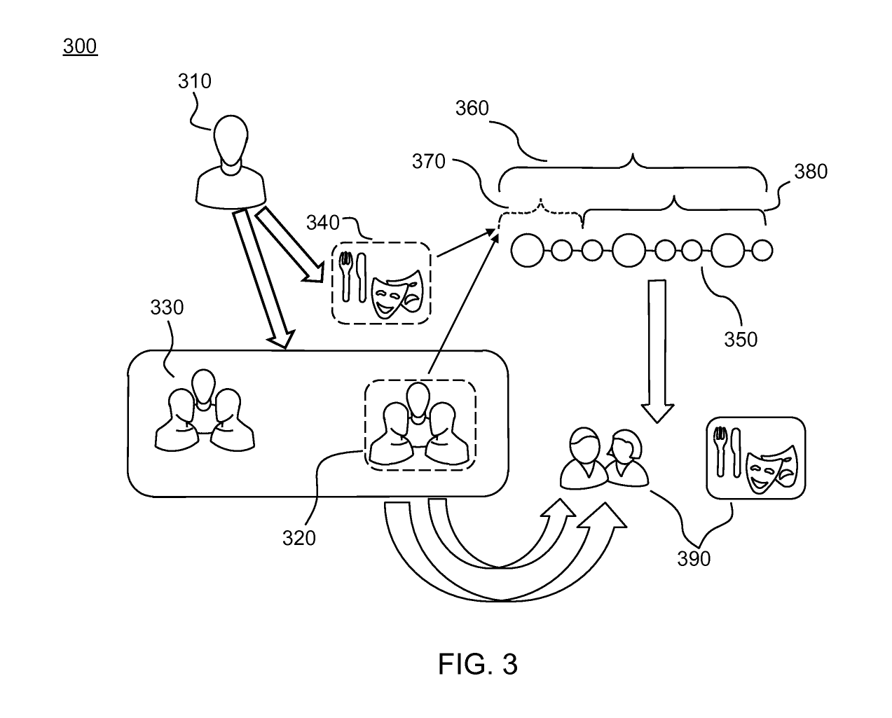

Referring to FIG. 3, a chart 300 illustrates in more detail selection of available meeting venues and friends, briefly discussed elsewhere herein in connection with the phase 235 on FIG. 2, according to an embodiment of the system described herein. A meeting organizer 310 starts a meeting setup process by selecting a preliminary list of desired friends 320 from an overall friend list 330 and creating a preliminary list of desired venues 340. The system may assist the organizer in building the list of venues 340 by offering directories of hot events, new venues, venue ratings, by looking into the past history of meetings of the organizer with some or all of the pre-selected friends, etc. The rest of planning may be performed by the system in a semi-automatic mode. For each meeting venue from the list 340 and each candidate (potential participant) of the meeting from the list 320 (including the organizer 310), the system first determines if the venue matches the candidate's area of interests and sorts out any mismatches. If a pair (venue, candidate) is a match, the system estimates available meeting time on a timeline 350. The system splits an announced spare time period 360 of a possible participant into an estimated travel time 370 based on the venue and the location of the candidate, traffic conditions and an estimated available meeting time 380. The system may calculate the travel time for different transportation methods. The system then filters out the pairs (venue, candidate) where either the travel time exceeds a maximum desired time set by the candidate or the residual available meeting time is shorter than a period required by the organizer and/or the candidate. The system leaves only a subset of pairs (venue, candidate) 390 where the organizer may meet at least one friend. Subsequently, such pairs may be grouped by venues. For each venue, the list of friends whom the organizer may meet at that meeting place is compiled.

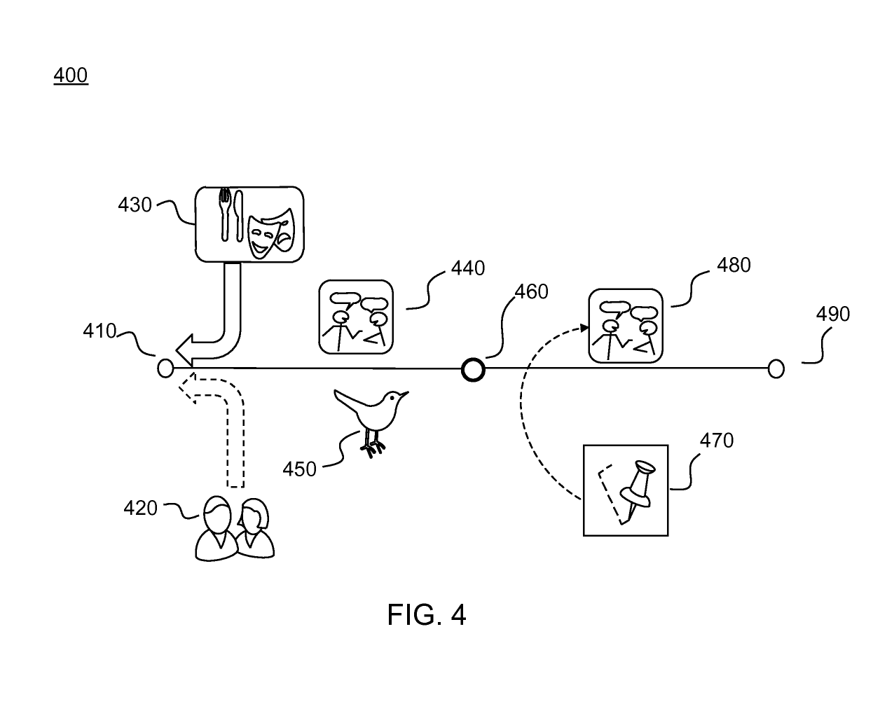

FIG. 4 is a schematic illustration 400 of an invitation, final choice of venue, meeting confirmation and travel processes. Once available venues with the corresponding groups of friends have been built by the system and presented to the meeting organizer, the organizer selects one or more of the favored venues and instructs the system to send invitations to all prospective participants. This is illustrated by an activity 410 where the friends list 420 who pay participate in at least one of a chosen favored venues 430 receive invitations. A dashed arrow near the list 420 illustrates the fact that the organizer's friends may receive information only about some of the venues that fit their preferences and time limitations, as explained elsewhere herein. Users may communicate in the process of choosing the best meeting place using different means, such as chat or online conferencing 440 or social networks 450. After the choice of meeting place is completed, confirmations from all or some of the participants may be received, an instameet group may be created and may also be broadcasted to non-participating mutual friends or to the public to join, as symbolically indicated by a timeline item 460. Subsequently, some or all of the confirmed meeting participants may travel to the meeting place and the system may track travel progress 470 of the participants and communicate the travel progress to other participants as illustrated by a communications box 480, until a traveling participant arrives to the meeting place and joins the rest, as illustrated by a timeline item 490.

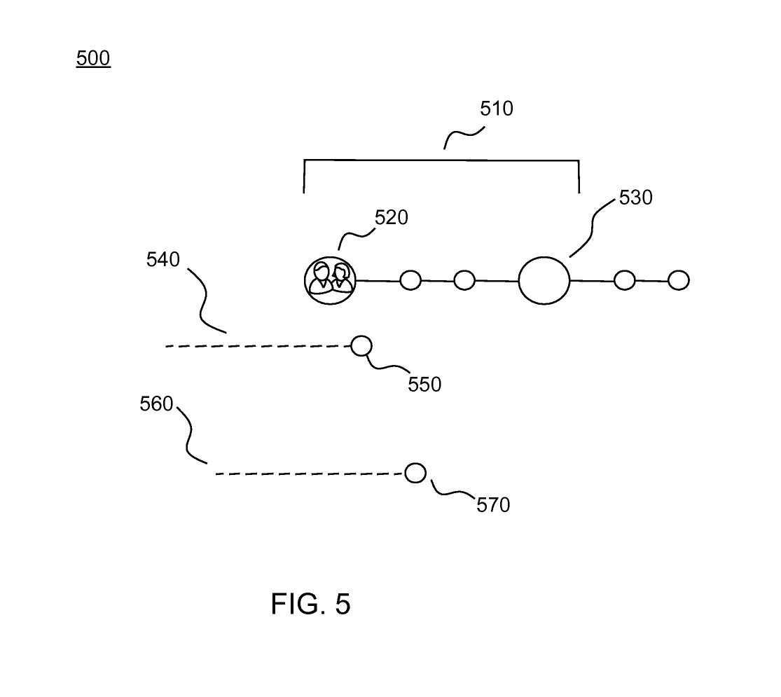

FIG. 5 is a schematic illustration 500 of a meeting with additional friends' arrivals. A meeting 510 starts at a time 520 when the first two meeting participants arrive to (and meet at) the meeting place. Traveling participants 540 may join the meeting at random times 550 between the start time 520 and an end time 530. Additional friends 560 may also join the meeting at random times 570 in the event that the meeting was communicated to friends or broadcasted via the system or through other social media.

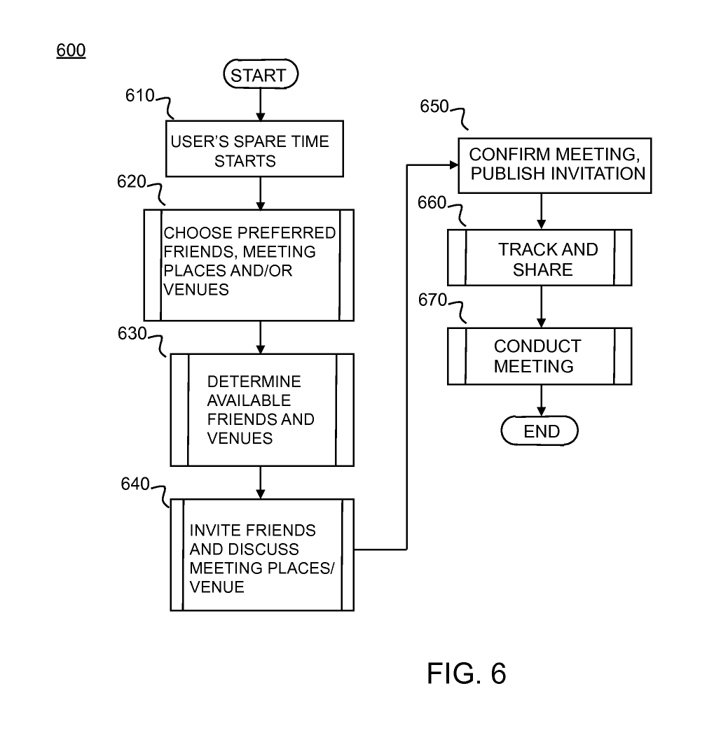

FIG. 6 is a flow diagram 600 illustrating initiating and conducting a meeting. Processing begins at a step 610 where a user's spare time starts and is communicated to the system. After the step 610, processing proceeds to a step 620 where the user chooses preferred friends (from the list, discussed elsewhere herein), a preliminary inventory of meeting places and/or venues and other requirements that are desirable for the meeting. After the step 620, processing proceeds to a step 630 where the system determines available friends and venues, as explained elsewhere herein (see descriptions for FIGS. 1-3).

After the step 630, processing proceeds to a step 640 where the available friends are invited to the matching meetings and the friends discuss meeting opportunities, as explained elsewhere herein (see descriptions for FIGS. 1, 2 and 4). After the step 640, processing proceeds to a step 650 where the meeting is confirmed, an instameet group is created and an additional invitation to the meeting is published, if applicable. After the step 650, processing proceeds to a step 660 where some or all of meeting participants may be traveling to the meeting place and their trips may be tracked by the system and shared with the rest of the participants. After the step 660, processing proceeds to a step 670 where the meeting occurs. Following the step 670, processing is complete.

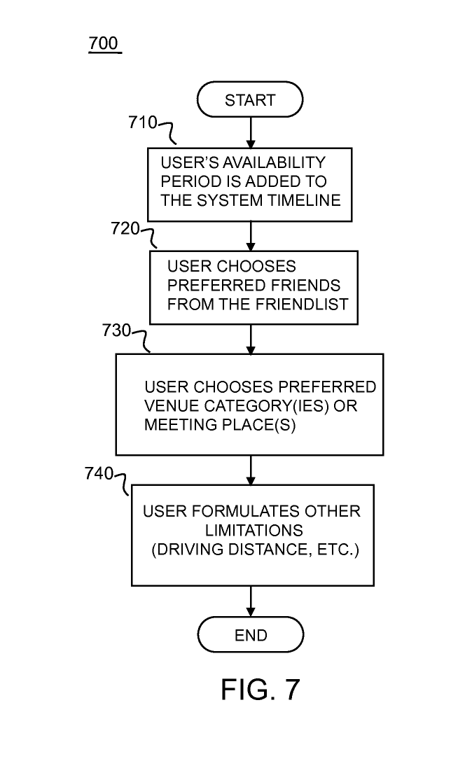

Referring to FIG. 7, a flow diagram 700 illustrates in more detail processing performed at the step 620, discussed above, where the user chooses preferred friends from the list, a preliminary inventory of meeting places and/or venues and formulates other requirements desirable for the meeting. Processing begins at a step 710 where a user's availability period is added to the system timeline. After the step 710, processing proceeds to a step 720 where the user chooses preferred friend for the particular meeting from the friend list. After the step 720, processing proceeds to a step 730 where the user may choose preferred venue categories for assisted suggestions by the system and/or specific meeting places. After the step 730, processing proceeds to a step 740 where the user formulates other requirements and limitations, such as maximum driving distance or time, minimum or maximum number of friends in the meeting, price limits, etc. Following the step 740, processing is complete.

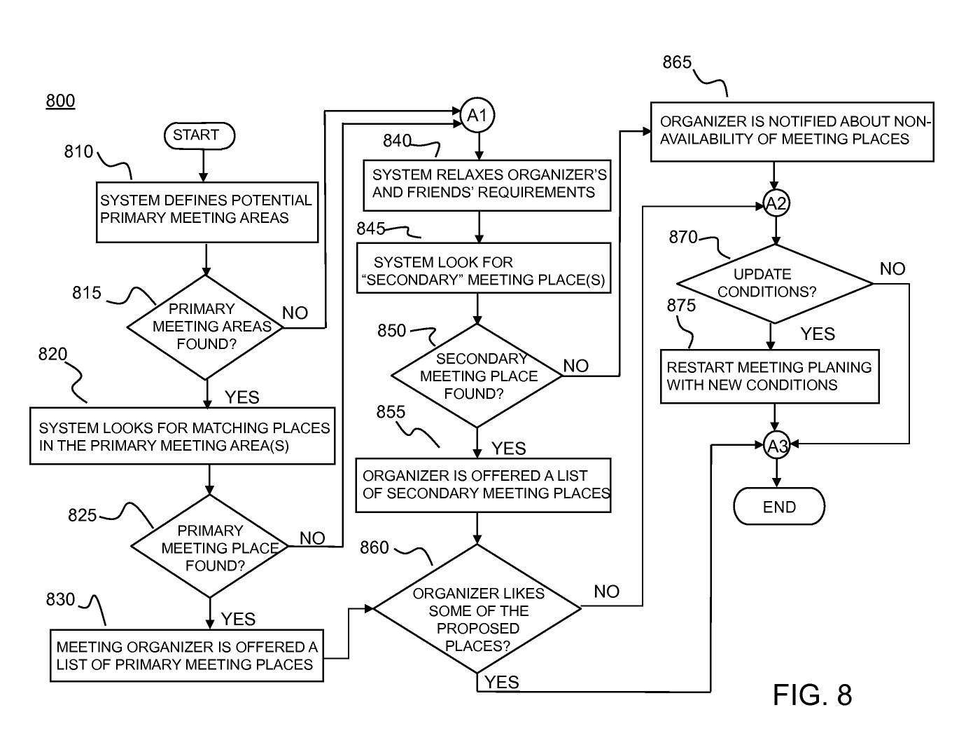

Referring to FIG. 8, a flow diagram 800 illustrates in more detail processing performed at the step 630, discussed above, where the system determines available friends and venues, subject to meeting organizer's requirements, according to an embodiment of the system described herein. Processing begins at a step 810 where the system defines potential primary meeting areas based on current requirements of the meeting organizer and on recorded requirements of friends from the pre-selected list. After the step 810, processing proceeds to a test step 815 where it is determined if a primary meeting area has been found by the system. If so, then processing proceeds to a step 820 where the system looks for matching places in the primary meeting area(s) found at the step 810 using calculations and criteria explained elsewhere herein (see descriptions to FIG. 3); otherwise, processing proceeds to a step 840.

After the step 820, processing proceeds to a test step 825 where it is determined if at least one primary meeting place was found. If so, then processing proceeds to a step 830 where the meeting organizer is offered a list of primary meeting places and the friends who may participate in each meeting based on recorded requirements of the friends; otherwise, processing proceeds to the step 840, which is also reached from the step 815 if primary meeting areas have not been found. At the step 840, the system relaxes meeting organizer's and friends' requirements within the admissible boundaries. After the step 840, processing proceeds to a step 845 where the system defines secondary meeting areas based on the relaxed requirements of the meeting organizer and the friends from the pre-selected list. After the step 845, processing proceeds to a test step 850 where it is determined if the secondary meeting areas have been found by the system. If so, then processing proceeds to a step 855 where the meeting organizer is offered a list of secondary meeting places and the friends who may participate in each meeting based on the relaxed requirements; otherwise, processing proceeds to a step 865. After each of the steps 830, 855, processing proceeds to a test step 860 where it is determined if the meeting organizer likes some of the proposed places (primary places in the case of reaching the step 860 from the step 830 and secondary places if the preceding step was the step 855). If so, then the list of available meeting places and the matching list(s) of friends who may participate in the meetings is found and the processing is complete; otherwise, processing proceeds to a test step 870, which is explained elsewhere herein.

At the step 865 which is reached from the test step 850 if it is determined that secondary meeting places have not been found, the meeting organizer is notified about the non-availability of meeting places satisfying the initial or relaxed requirements. After the step 865, processing proceeds to the test step 870 that is also reached from the step 860 as described above. At the test step 870, it is determined whether the meeting organizer is willing to update the conditions for the system search of a meeting place. If so, then processing proceeds to a step 875 where new conditions are communicated and the system restarts meeting planning with the new conditions; otherwise, processing is complete without finding matching meeting places. After the step 875, processing is complete.

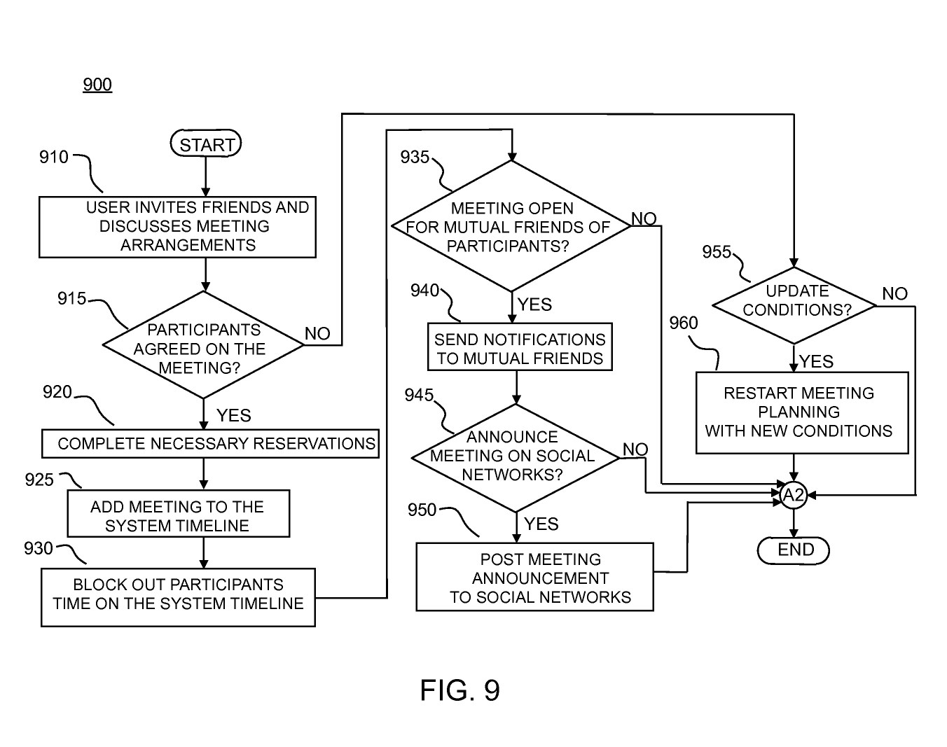

Referring to FIG. 9, a flow diagram 900 illustrates in more detail processing of invitations and setup of an instameet group performed at the step 640, discussed above (see descriptions in relation to FIG. 4). Processing begins at a step 910 where the user invites friends via the system and discusses with them meeting choices (if multiple meetings are available) and arrangements. After the step 910, processing proceeds to a test step 915 where it is determined if the participants have chosen a meeting and agreed on meeting arrangements. If so, processing proceeds to a step 920; otherwise, processing proceeds to a step 955. At the step 920, necessary reservations (if any) in conjunction with the meeting are completed.

After the step 920, processing proceeds to a step 925 where an instameet group is created and the meeting is confirmed and added to the system timeline. After the step 925, processing proceeds to a step 930 where the participants meeting time is blocked out on the system timeline. After the step 930, processing proceeds to a test step 935 where it is determined if the meeting is open for some or all of the mutual friends of participants who were not included on the initial list of the meeting organizer If so, processing proceeds to the step 940 where meeting notifications are sent to such mutual friends; otherwise, processing is complete. After the step 940, processing proceeds to a test step 945 where it is determined if the participants also wish to announce the meeting on social networks (including the present system). If so, processing proceeds to the step 950 to post the meeting to social networks; otherwise, processing is complete. Processing is also complete after the step 950.

At the test step 955 (which is reached from the step 915 if it turned out that the participants have not agreed on the meeting), it is determined if the participants wish to update conditions for a meeting search. If not, then processing is complete without a meeting; otherwise, processing proceeds to a step 960 where the new conditions are communicated and the system restarts meeting planning with the new conditions. After the step 960, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The system described herein may be implemented using a cell phone, although other devices are also possible.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of arranging a meeting between participants, comprising:
choosing a set of possible meeting participants;
choosing a set of possible meeting times;
choosing a set of possible meeting venues;
announcing a possible meeting without knowledge of availability of at least some of the set of possible meeting participants;
receiving, from at least some of the set of possible participants, preferences for at least one of: proposed meeting times and proposed meeting venues;
automatically selecting a subset of meeting participants to meet at at least one particular location at at least one particular time at at least one particular venue according to preferences and availability of at least some of the set of possible meeting participants, wherein the subset of meeting participants is less than the set of possible meeting participants and wherein the subset of meeting participants is chosen based on the particular meeting venues and times; and
sending an invitation to the subset of meeting participants.

2. A method, according to claim 1, wherein a first one of the participants is a meeting organizer that initially chooses the set of possible meeting participants, the set of possible meeting times, and the set of possible meeting venues.

3. A method, according to claim 2, wherein a second one of the participants becomes the meeting organizer while the first one of the participants is no longer the meeting organizer.

4. A method, according to claim 2, wherein, prior to sending the invitation, the meeting organizer eliminates choices from at least one of: the subset of meeting participants, the at least one particular location, the at least one particular time, and the at least one particular venue.

5. A method, according to claim 2, wherein, in response to the subset of meeting participants being less than two, the organizer relaxes requirements for the meeting by at least one of: choosing more possible meeting participants, adding possible meeting venues, adding possible meeting times, and expanding already-specified possible meeting times.

6. A method, according to claim 1, wherein, after receiving the invitation, the subset of meeting participants select at least one of: the at least one particular location, the at least one particular time, and the at least one particular venue.

7. A method, according to claim 1, wherein the subset of meeting participants is determined based at least in part on travel time for each of the possible meeting participants to a location of each of the set of possible meeting venues.

8. A method, according to claim 1, wherein the subset of meeting participants negotiate a best meeting place and time after receiving the invitations.

9. A method, according to claim 8, wherein following agreeing on a meeting place and time, confirmations and final meeting details are sent to the subset of meeting participants.

10. A method, according to claim 8, wherein following agreeing on a meeting place and time, a number of members of the subset of meeting participants is decreased.

11. A method, according to claim 8, wherein following agreeing on a meeting place and time, travel and meeting times is blocked out for all of the subset of meeting participants.

12. A method, according to claim 8, wherein following agreeing on a meeting place and time, the meeting place and time is announced via social networks for others to join.

13. A method, according to claim 8, wherein following agreeing on a meeting place and time, tracking information about at least some of the subset of meeting participants with location aware mobile devices is provided to other ones of the participants.

14. A method, according to claim 8, wherein following agreeing on a meeting place and time, the meeting place and time is provided to invite others to join the meeting and wherein the others are not part of the set of possible meeting participants.

15. A method, according to claim 1, wherein the set of possible meeting venues includes virtual meeting venues.

16. A method, according to claim 1, wherein the set of possible meeting venues includes at least one venue that is mixed real and virtual, wherein some of the set of possible meeting participants meet in-person while others meet virtually.

17. Computer software, provided in a non-transitory computer-readable medium, that arranges a meeting between participants, the software comprising:
executable code that announces a possible meeting at possible meeting times and at possible meeting venues without knowledge of availability of at least some of a set of possible meeting participants;
executable code that receives from at least some of the set of possible participants preferences for at least one of: proposed meeting times and proposed meeting venues;
executable code that selects a subset of meeting participants to meet at at least one particular location at at least one particular time at at least one particular venue according to preferences and availability of at least some of the set of possible meeting participants, wherein the subset of meeting participants is less than the set of possible meeting participants and wherein the subset of meeting participants is chosen based on the particular meeting venues and times; and
executable code that sends an invitation to the subset of meeting participants.

18. Computer software, according to claim 17, wherein a first one of the participants is a meeting organizer that initially chooses the set of possible meeting participants, the possible meeting times, and the possible meeting venues.

19. Computer software, according to claim 18, wherein a second one of the participants becomes the meeting organizer while the first one of the participants is no longer the meeting organizer.

20. Computer software, according to claim 18, wherein, in response to the subset of meeting participants being less than two, the requirements are relaxed for the meeting by at least one of: more possible meeting participants being chosen, possible meeting venues being added, possible meeting times being added, and already-specified possible meeting times being expanded.

21. Computer software, according to claim 17, wherein the subset of meeting participants is determined based at least in part on travel time for each of the possible meeting participants to a location of each of the possible meeting venues.

22. Computer software, according to claim 17, further comprising:
executable code that sends confirmations and final meeting details to the subset of meeting participants.

23. Computer software, according to claim 17, further comprising:
executable code that blocks out travel and meeting times for all of the subset of meeting participants.

24. Computer software, according to claim 17, further comprising:
executable code that announces the meeting place and time via social networks for others to join.

25. Computer software, according to claim 17, further comprising:
executable code that tracks information about at least some of the subset of meeting participants with location aware mobile devices and provides the information to other ones of the participants.

26. Computer software, according to claim 17, further comprising:
executable code that provides the meeting place and time to invite others to join the meeting, wherein the others are not part of the set of possible meeting participants.

27. Computer software, according to claim 17, wherein the possible meeting venues includes virtual meeting venues.

28. Computer software, according to claim 17, wherein the possible meeting venues includes at least one venue that is mixed real and virtual, wherein some of the set of possible meeting participants meet in-person while others meet virtually.
